(19) United States
(12) Patent Application Publication
(10) Pub. No.: US 2026/0196533 A1
(43) Pub. Date: Jul. 9, 2026

(54) FUEL CELL

(71) Applicant: TOYOTA JIDOSHA KABUSHIKI KAISHA, Toyota-shi, Aichi (JP)

(72) Inventors: Kazunori SHIBATA, Mishima-shi (JP); Kotaro IKEDA, Susono-shi (JP); Rannosuke MAEDA, Susono-shi (JP)

(21) Appl. No.: 19/410,036

(22) Filed: Dec. 5, 2025

(30) Foreign Application Priority Data
Jan. 6, 2025 (JP) 2025-001881

(51) Int. Cl. H01M 8/0297; H01M 8/0273

(52) U.S. Cl. CPC H01M 8/0297; H01M 8/0273

(57) ABSTRACT

A fuel cell may include a power generation section including a membrane electrode assembly, a frame-shaped insulating member surrounding an outer periphery of the power generation section and a first separator and a second separator interposing the power generation section and the insulating member therebetween in a stacking direction. The first separator may comprise a first spring protruding toward the insulating member from a first facing surface of the first separator that faces the insulating member, the second separator may comprise a second spring protruding toward the insulating member from a second facing surface of the second separator that faces the insulating member, and the first spring and the second spring may have asymmetrical shapes with respect to the insulating member and interpose the insulating member therebetween.

### SPECIFICATION

### CROSS REFERENCE TO RELATED APPLICATIONS

This application claims priority from Japanese Patent Application No. 2025-1881 filed on January 6, 2025. The entire content of the priority application is incorporated herein by reference.

### TECHNICAL FIELD

The art disclosed herein relates to a fuel cell.

### BACKGROUND ART

A fuel cell is known that includes a membrane electrode assembly (abbreviated as MEA) in which an anode electrode is disposed on one surface of an electrolyte membrane and a cathode electrode is disposed on the opposing surface of the electrolyte membrane, and separators disposed on respective sides of the MEA. Such a fuel cell may be referred to as a single cell or a power generation cell. In general, a fuel cell stack is formed by stacking multiple power generation cells.

Japanese Patent Application Publication No. 2021-15766 describes a separator that is stacked with an MEA to form a power generation cell and the separator includes a bead seal that protrudes in the stacking direction with the MEA and prevents leakage of fluid. The bead seal functions as a metallic spring and, in a section perpendicular to the seal line, includes a curved portion having an apex that protrudes most in the stacking direction and side portions that are located on both sides of the curved portion and have a softer spring characteristic than the curved portion.

### SUMMARY

In a fuel cell, each of the stacked layers, such as an MEA and separators, may have dimensional errors. Therefore, it is important for a spring, which is part of the separator, to have sufficient deformability so that it can provide sealing performance to prevent fluid leakage even if there are such dimensional errors. According to Japanese Patent Application Publication No. 2021-15766, to secure deformability in the stacking direction, the bead seal has a two-stage-shaped spring that includes the curved portion including the apex and softer side portions located on both sides of the curved portion.

The two-stage-shaped bead seal may pose a problem of increasing the seal line width. The disclosure herein provides technology useful for solving this problem and suitable for securing required deformability.

A fuel cell may comprise a power generation section including a membrane electrode assembly, a frame-shaped insulating member surrounding an outer periphery of the power generation section and a first separator and a second separator interposing the power generation section and the insulating member therebetween in a stacking direction. The first separator may comprise a first spring protruding toward the insulating member from a first facing surface of the first separator that faces the insulating member, the second separator may comprise a second spring protruding toward the insulating member from a second facing surface of the second separator that faces the insulating member, and the first spring and the second spring may have asymmetrical shapes with respect to the insulating member and interpose the insulating member therebetween.

According to the above configuration, the first spring and the second spring have asymmetric shapes with respect to the insulating member and interpose the insulating member therebetween, so that when they are stacked with the insulating member interposed therebetween, deformation is promoted. Therefore, the first spring and the second spring can secure appropriate deformability and provide excellent sealing performance without using a conventional two-stage shape.

### BRIEF DESCRIPTION OF DRAWINGS

FIG. 1 is an exploded perspective view of a fuel cell.

FIG. 2A is cross-sectional views perpendicular to a first seal line and a second seal line taken along a line II-II in FIG. 1, illustrating the shapes of a first spring and a second spring according to a first embodiment.

FIG. 2B is cross-sectional views perpendicular to a first seal line and a second seal line taken along a line II-II in FIG. 1, illustrating the shapes of a first spring and a second spring according to a first embodiment.

FIG. 3 is a diagram illustrating shapes of the first spring and the second spring according to the first embodiment that are different from those in FIG. 2A and FIG. 2B.

FIG. 4 is a diagram illustrating shapes of the first spring and the second spring according to the first embodiment that are different from those in FIG. 2A, FIG. 2B and FIG. 3.

FIG. 5A is a cross-sectional view perpendicular to the first seal line and the second seal line taken along the line II-II of FIG. 1, illustrating the shapes of a first spring and a second spring according to a second embodiment.

FIG. 5B is a cross-sectional view perpendicular to the first seal line and the second seal line taken along the line II-II of FIG. 1, illustrating the shapes of a first spring and a second spring according to a second embodiment.

FIG. 6 is a diagram illustrating shapes of the first spring and the second spring according to the second embodiment that are different from those in FIG. 5A and FIG. 5B.

FIG. 7 is a diagram illustrating shapes of the first spring and the second spring according to the second embodiment that different from those in FIG. 5A, FIG. 5B and FIG.

FIG. 8A is a cross-sectional view perpendicular to the first seal line and the second seal line taken along the line II-II of FIG. 1, illustrating the shapes of a first spring and a second spring according to a third embodiment.

FIG. 8B is a cross-sectional view perpendicular to the first seal line and the second seal line taken along the line II-II of FIG. 1, illustrating the shapes of a first spring and a second spring according to a third embodiment.

FIG. 9 is a cross-sectional view perpendicular to the first seal line and the second seal line taken along the line II-II of FIG. 1, illustrating the shapes of a first spring and a second spring according to a modification.

### DETAILED DESCRIPTION

In one embodiment of the present teachings, the first spring may comprise a first inclined surface inclined relative to the first facing surface, the second spring may comprise a second inclined surface inclined relative to the second facing surface, and the first spring and the second spring may interpose the insulating member between the first inclined surface and the second inclined surface. According to the above configuration, when the first spring and the second spring clamp the insulating member therebetween, the first inclined surface and the second inclined surface receive not only a force in the stacking direction but also a force in a direction orthogonal to the stacking direction, so that deformation is promoted.

In one embodiment of the present teachings, the first inclined surface may comprise a first convex portion protruding toward the insulating member and a first concave portion depressed toward the first facing surface, and the second inclined surface may comprise a second concave portion depressed toward the second facing surface at a position corresponding to a position of the first convex portion and a second convex portion protruding toward the insulating member at a position corresponding to a position of the first concave portion. According to the above configuration, the insulating member is clamped between the first convex portion and the second concave portion and is also clamped between the first concave portion and the second convex portion, so that the insulating member is firmly positioned between the first spring and the second spring.

In one embodiment of the present teachings, a width of a bottom portion of the first spring in a first direction perpendicular to the stacking direction may be different from a width of a bottom portion of the second spring in the first direction. According to the above configuration, deformation of the first spring and/or the second spring is promoted upon clamping the insulating member due to the difference in widths of their bottom portions.

In one embodiment of the present teachings, a convex portion protruding toward the insulating member may be formed on one of a top portion of the first spring and a top portion of the second spring, and a concave portion depressed away from the insulating member may be formed on other of the top portion of the first spring and the top portion of the second spring at a position corresponding to a position of the convex portion. According to the above configuration, the first spring and the second spring actively deform, with the insulating member interposed therebetween, by the convex portion and the concave portion engaging each other.

Referring to the drawings, embodiments will be described. The drawings are illustrative only, and the embodiments are not limited to what is illustrated. Some portions may be omitted in the drawings since they are only illustrative.

### First Embodiment

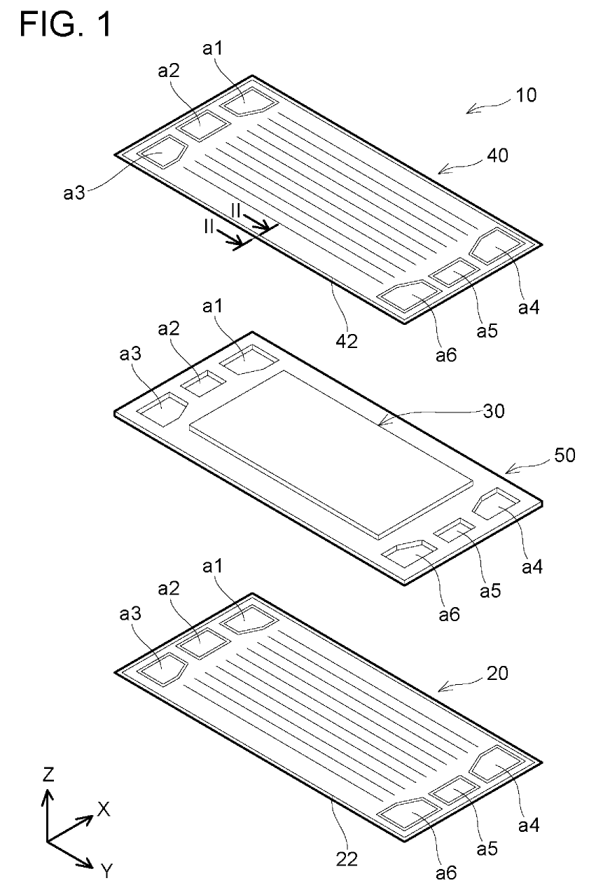

FIG. 1 is an exploded perspective view of a fuel cell 10 according to the present embodiment. A fuel cell stack is formed by stacking a plurality of fuel cells 10 in a Z direction. A single fuel cell 10 may be referred to as a single cell or a power generation cell. General description about fuel cells and fuel cell stacks can be obtained by appropriately referring to known art such as Japanese Patent Application Publication No. 2020-198200, and thus will be only briefly described here.

FIG. 1 shows X, Y and Z directions that are perpendicular to each other. The X direction and the Y direction correspond to the short direction and longitudinal direction of the substantially rectangular-shaped fuel cell 10, respectively. The Z direction corresponds to the stacking direction of the fuel cell 10. The fuel cell 10 is a solid polymer fuel cell that generates power from anode gas (e.g., hydrogen) and cathode gas (e.g., oxygen). The fuel cell 10 includes a membrane electrode gas diffusion layer assembly 30, a frame-shaped insulating member 50, and a pair of separators 20, 40. The membrane electrode gas diffusion layer assembly 30 is abbreviated as MEGA 30. The frame-shaped insulating member 50 may be referred to as the frame.

For example, the separator 20 is an anode-side separator and the separator 40 is a cathode-side separator. One of the separators 20 and 40 corresponds to “first separator” and the other corresponds to “second separator”. Although any one of the separators 20 and 40 can correspond to the first separator, the separator 20 will be referred to as the first separator 20 and the separator 40 will be referred to as the second separator 40 hereinafter.

The MEGA 30 includes an MEA in which an anode electrode catalytic layer is joined to one surface of an electrolyte membrane and a cathode electrode catalytic layer is joined to the opposite surface of the electrode membrane, and two gas diffusion layers respectively joined to both surfaces of the MEA. The MEGA 30 is an example of “power generation section including a membrane electrode assembly”. The insulating member 50 is, for example, a resin sheet. The inner periphery of the frame-shaped insulating member 50 abuts the outer periphery of the MEGA 30 so as to surround the outer periphery of the MEGA 30. The first separator 20 is disposed on -Z direction side relative to the MEGA 30 and the insulating member 50, and the second separator 40 is disposed on +Z direction side relative to the MEGA 30 and the insulating member 50. In the Z direction, the MEGA 30 and the insulating member 50 are interposed between the first separator 20 and the second separator 40.

Each of the first separator 20, the second separator 40, and the insulating member 50 has through-holes a1 to a6 that penetrate them in the Z direction. The through-holes a1 to a6 define an inlet manifold and an outlet manifold for each of various fluids such as anode gas, cathode gas, and cooling medium. Each of these fluids flows through a flow channel extending between the corresponding inlet manifold and outlet manifold. The flow channels are formed in the first separator 20 and the second separator 40. The first separator 20 and the second separator 40 are gas-impermeable and electrically conductive and are, for example, thin plate members formed of a metal such as press-formed stainless steel, titanium, or titanium alloy.

The first separator 20 includes a first seal line 22 that extends along the outer periphery of the first separator 20. The second separator 40 includes a second seal line 42 that extends along the outer periphery of the second separator 40. The first seal line 22 surrounds the flow channels and the through-holes a1 to a6 formed in the first separator 20, and the second seal line 42 surrounds the flow channels and the through-holes a1 to a6 formed in the second separator 40. The first seal line 22 is provided by first springs 26, which will be described below, extending in the X and Y directions as shown in FIG. 1. Similarly, the second seal line 42 is provided by second springs 46, which will be described below, extending in the X and Y directions. The first seal line 22 and the second seal line 42 prevent leakage of the anode gas and cathode gas by clamping the insulating member 50 in the Z direction.

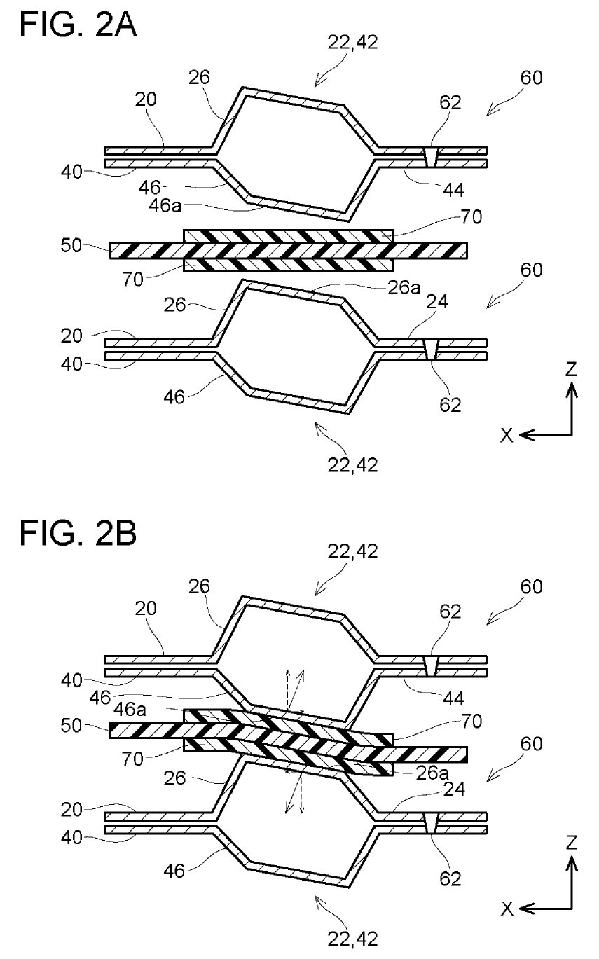

FIG. 2A and FIG. 2B schematically illustrate partial cross sections of the fuel cell 10 taken along the line II-II in FIG. 1 and the cross sections are perpendicular to the first seal line 22 and the second seal line 42. FIG. 2A illustrates a state before the insulating member 50 is clamped by a pair of the first separator 20 and the second separator 40, and FIG. 2B illustrates a state after the insulating member 50 has been clamped by the pair of the first separator 20 and the second separator 40. As illustrated in FIG. 2A and FIG. 2B, a separator assembly 60 is disposed on the +Z direction side relative to the insulating member 50. Similarly, another separator assembly 60 is disposed on the -Z direction side relative to the insulating member 50. Each separator assembly 60 is constituted by a first separator 20 and a second separator 40 joined to each other.

The first separator 20 and the second separator 40 of each separator assembly 60 are joined at a joining line 62. The joining may be, for example, welding. Alternatively, the first separator 20 and the second separator 40 of each separator assembly 60 may be joined at the joining line 62 by adhesive bonding or caulking. Although omitted in FIG. 1, the joining lines 62 extend along the outer peripheries of the separators 20 and 40 similarly to the seal lines 22, 42. The joining lines 62 may be located either outward of or inward of the seal lines 22, 42.

In FIG. 2A and FIG. 2B, the first separator 20 of the separator assembly 60 located on the +Z direction side relative to the insulating member 50 is naturally used to clamp another insulating member 50 (not illustrated) that is located on the +Z direction side relative to that first separator 20. In FIG. 2A and FIG. 2B, the second separator 40 of the separator assembly 60 located on the -Z direction side relative to the insulating member 50 is used to clamp another insulating member 50 (not illustrated) located on the -Z direction side relative to that second separator 40.

The first separator 20 comprises a first spring 26 protruding toward the insulating member 50 (toward the +Z direction side in the example of FIG. 2A and FIG. 2B) from a first facing surface 24 of the first separator 20 that faces the insulating member 50. The second separator 40 comprises a second spring 46 protruding toward the insulating member 50 (toward the -Z direction side in the example of FIG. 2A and FIG. 2B) from a second facing surface 44 of the second separator 40 that faces the insulating member 50. The first facing surface 24 and the second facing surface 44 may be regarded as surfaces perpendicular or substantially perpendicular to the Z direction. The insulating member 50 extends parallel or substantially parallel to the first and second facing surfaces 24, 44. Focusing on one separator assembly 60, the first spring 26 and the second spring 46 protrude opposite in the Z direction.

The first spring 26 and the second spring 46 may directly contact the insulating member 50. In one example, as illustrated, a flexible seal member 70 is interposed between the first spring 26 and the insulating member 50 and between the second spring 46 and the insulating member 50 to provide enhanced sealing. The seal members 70 are, for example, film-like rubber members. The seal members 70 may be referred to as gaskets. In the example of FIG. 2A, the seal members 70 are disposed on the insulating member 50 in the state before the first spring 26 and the second spring 46 clamp the insulating member 50, however, the seal members 70 may be disposed on the first spring 26 and second spring 46 alternatively. In the disclosure herein, irrespective of whether the seal members 70 are present or not, the expression “the first spring 26 and the second spring 46 clamp the insulating member 50” is used for simplicity.

One feature disclosed herein is that the first spring 26 and the second spring 46 have asymmetric shapes with respect to the insulating member 50. That is, the first spring 26 and the second spring 46 having asymmetric shapes with respect to the insulating member 50 clamp the insulating member 50 therebetween.

In the first embodiment, the first spring 26 comprises a first inclined surface 26a inclined relative to the first facing surface 24. The second spring 46 comprises a second inclined surface 46a inclined relative to the second facing surface 44. The first spring 26 and the second spring 46 clamp the insulating member 50 by the first inclined surface 26a and the second inclined surface 46a.

As illustrated in FIG. 2A and FIG. 2B, the first inclined surface 26a and the second inclined surface 46a are parallel or substantially parallel to each other. The first spring 26 and the second spring 46 press against each other upon clamping the insulating member 50 therebetween under a load toward the insulating member 50. At this time, each of the first inclined surface 26a and the second inclined surface 46a receives not only a force in the Z direction but also a force in a direction perpendicular to the Z direction (in the X direction in FIG. 2B), as illustrated by the arrow in FIG. 2B, thereby promoting deformation of the first spring 26 and the second spring 46. As illustrated in FIG. 2B, a portion of the insulating member 50 that is clamped between the first inclined surface 26a and the second inclined surface 46a is deformed following the inclinations of the first inclined surface 26a and the second inclined surface 46a and becomes inclined compared to the plane of the insulating member 50 before the clamping.

As illustrated in FIG. 2A and FIG. 2B, the first spring 26 is formed from a plurality of surfaces including the first inclined surface 26a, which is used to clamp the insulating member 50, that are connected to each other. Similarly, the second spring 46 is formed from a plurality of surfaces including the second inclined surface 46a, which is used to clamp the insulating member 50, that are connected to each other. According to FIG. 2A and FIG. 2B, it can be expressed that the position of the apex of the first spring 26 that protrudes most toward the insulating member 50 is offset from the position of the apex of the second spring 46 that protrudes most toward the insulating member 50 in a direction perpendicular to the Z direction.

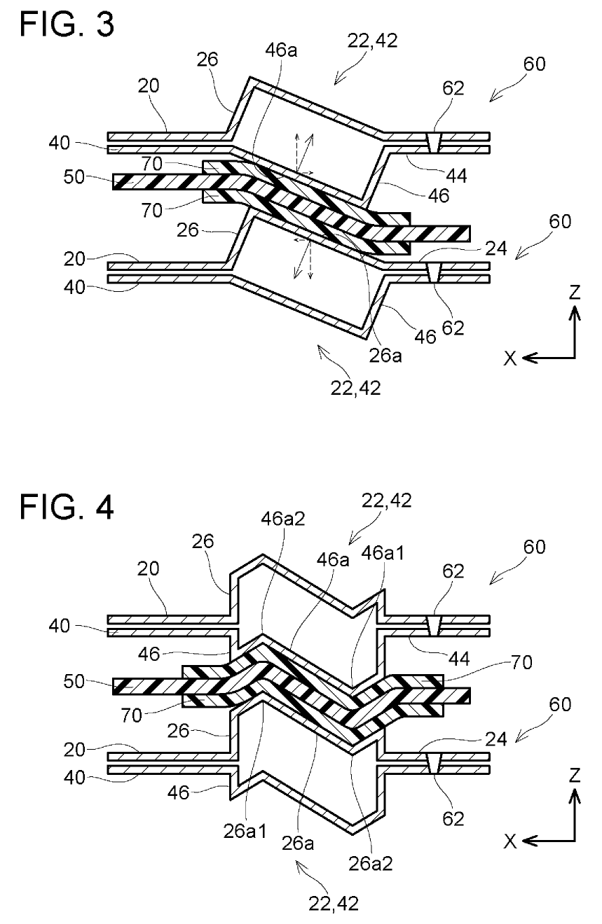

FIGS. 3 and 4 each illustrate cross sections perpendicular to the first seal line 22 and the second seal line 42 from the same viewpoint as FIG. 2A and FIG. 2B. FIGS. 3 and 4 disclose shapes of the first spring 26 and the second spring 46 different from those illustrated in FIG. 2A and FIG. 2B. Descriptions common to FIG. 2A and FIG. 2B are omitted for FIGS. 3 and 4.

According to FIG. 3, the number of surfaces forming the first spring 26 is smaller than that of the first spring 26 illustrated in FIG. 2A and FIG. 2B. The first spring 26 of FIG. 2A and FIG. 2B is formed from three surfaces connected at angles to each other, whereas the first spring 26 of FIG. 3 is formed of two surfaces connected at an angle to each other. Similarly, according to FIG. 3, the number of surfaces forming the second spring 46 is smaller than that of the second spring 46 illustrated in FIG. 2A and FIG. 2B. The second spring 46 of FIG. 2A and FIG. 2B is formed from three surfaces connected at angles to each other, whereas the second spring 46 of FIG. 3 is formed from two surfaces connected at an angle to each other. According to the example of FIG. 3, the first spring 26 including the first inclined surface 26a and the second spring 46 including the second inclined surface 46a can be formed with simpler shapes.

According to FIG. 4, the first inclined surface 26a of the first spring 26 includes a first convex portion 26a1 protruding toward the insulating member 50 and a first concave portion 26a2 depressed toward the first facing surface 24. The second inclined surface 46a of the second spring 46 includes a second concave portion 46a2 depressed toward the second facing surface 44 corresponding to the position of the first convex portion 26a1 and a second convex portion 46a1 protruding toward the insulating member 50 corresponding to the position of the first concave portion 26a2. That is, according to FIG. 4, the first convex portion 26a1 and the second concave portion 46a2 fit together with the insulating member 50 interposed therebetween. Similarly, the second convex portion 46a1 and the first concave portion 26a2 fit together with the insulating member 50 interposed therebetween. A portion of the insulating member 50 that is clamped by the first convex portion 26a1 and the second concave portion 46a2 and a portion of the insulating member 50 that is clamped by the second convex portion 46a1 and the first concave portion 26a2 are bent in opposite directions. According to the example of FIG. 4, the insulating member 50 is more securely positioned between the first spring 26 and the second spring 46.

### Second Embodiment

Next, a second embodiment will be described. For the second embodiment and a third embodiment, which will be described below, descriptions common to the first embodiment are omitted. Regarding the feature that the first spring 26 and the second spring 46 have asymmetric shapes with respect to the insulating member 50, a bottom portion of the first spring 26 and a bottom portion of the second spring 46 may differ from each other in the width and/or position.

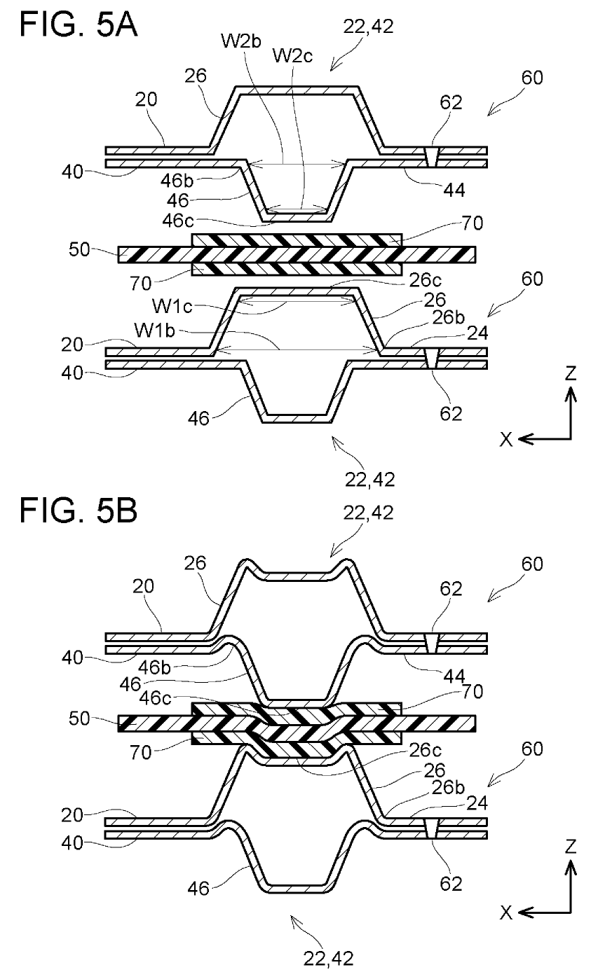

FIG. 5A and FIG. 5B illustrate a cross section perpendicular to the first seal line 22 and the second seal line 42 from the same viewpoint as FIG. 2A and FIG. 2B. FIG. 5A illustrates a state before the insulating member 50 is clamped by a pair of the first separator 20 and the second separator 40, and FIG. 5B illustrates a state after the insulating member 50 has been clamped by the pair of the first separator 20 and the second separator 40. FIG. 5A and FIG. 5B disclose shapes of the first spring 26 and the second spring 46 according to the second embodiment.

The bottom portion of the first spring 26 (first bottom portion 26b) can be regarded as the rising portion of the first spring 26 from the first facing surface 24 or as the root portion of the first spring 26. Alternatively, the range of the first spring 26 within the first facing surface 24 may be regarded as the first bottom portion 26b. Similarly, the bottom portion of the second spring 46 (second bottom portion 46b) can be regarded as the rising portion of the second spring 46 from the second facing surface 44 or as the root portion of the second spring 46. Alternatively, the range of the second spring 46 within the second facing surface 44 may be regarded as the second bottom portion 46b.

In the second embodiment, a width W1b of the first bottom portion 26b of the first spring 26 in a direction perpendicular to the Z direction (in the X direction in FIG. 5A and FIG. 5B) is different from a width W2b of the second bottom portion 46b of the second spring 46 in the direction perpendicular to the Z direction (in the X direction in FIG. 5A and FIG. 5B). The X direction is an example of “first direction” perpendicular to the stacking direction. FIG. 5A and FIG. 5B illustrate the relationship W1b > W2b. Focusing on one separator assembly 60, the width W2b is contained within the width W1b. Therefore, focusing on one separator assembly 60, the first bottom portion 26b can be supported by the planar portion of the second separator 40, while the second bottom portion 46b cannot be supported by the planar portion of the first separator 20. However, the relationship W1b < W2b can be contemplated.

Further, according to FIG. 5A and FIG. 5B, a width W1c of a top portion of the first spring 26 (first top portion 26c) in the X direction is larger than a width W2c of a top portion of the second spring 46 (second top portion 46c) in the X direction. The first top portion 26c is a portion or a surface of the first spring 26 that is configured to clamp the insulating member 50. According to FIG. 5A and FIG. 5B, the first top portion 26c is a surface parallel or substantially parallel to the first facing surface 24. In the first embodiment, the first inclined surface 26a corresponds to the first top portion 26c. The second top portion 46c is a portion or a surface of the second spring 46 that is configured to clamp the insulating member 50. According to FIG. 5A and FIG. 5B, the second top portion 46c is a surface parallel or substantially parallel to the second facing surface 44. In the first embodiment, the second inclined surface 46a corresponds to the second top portion 46c.

When the first spring 26 and the second spring 46 press against each other to clamp the insulating member 50, as illustrated in FIG. 5B, the planar portion of the second separator 40 near the second bottom portion 46b is deformed in the direction opposite to the protruding direction of the second spring 46 due to the difference between the width W1b of the first bottom portion 26b and the width W2b of the second bottom portion 46b, that is, due to the relationship W1b > W2b. Further, as illustrated in FIG. 5B, a central part of the first top portion 26c is pushed by the second top portion 46c and becomes depressed due to the relationship the width W1c of the first top portion 26c > the width W2c of the second top portion 46c. The portion of the insulating member 50 that is clamped by the first top portion 26c and the second top portion 46c is deformed following the depression of the first top portion 26c. Thus, according to the second embodiment, deformation of the first spring 26 and/or of the second spring 46 especially in the Z direction are prompted when the first spring 26 and the second spring 46 clamp the insulating member 50, by the difference in the bottom portion width and/or the difference in the top portion width.

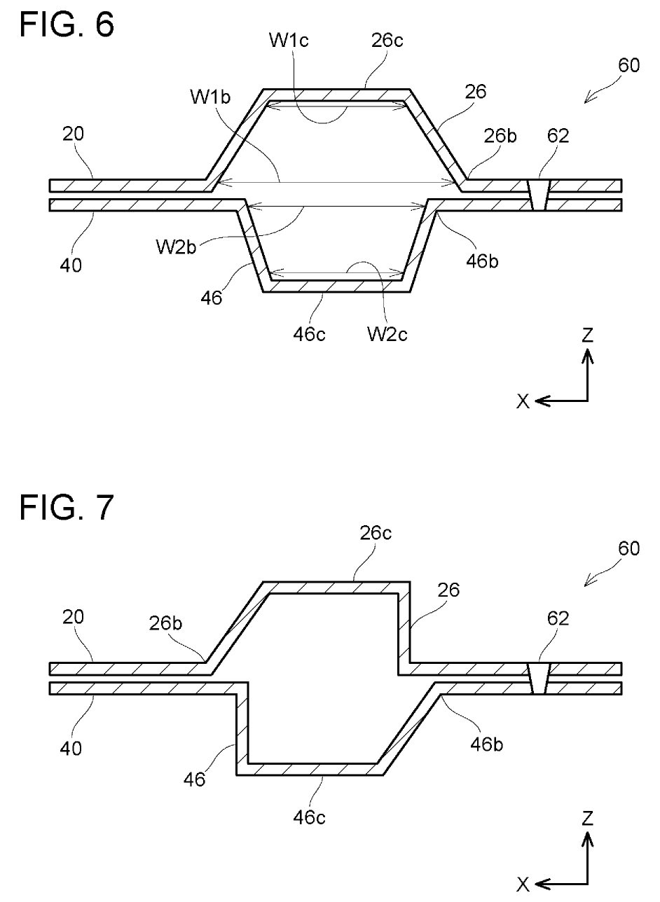

FIGS. 6 and 7 each illustrate cross sections of one separator assembly 60 from the same viewpoint as FIG. 5A and FIG. 5B. The separator assembly 60 and the insulating member 50 are stacked in the Z direction in the same way as described above. Each of FIGS. 6 and 7 discloses shapes of the first spring 26 and the second spring 46 different from those illustrated in FIG. 5A and FIG. 5B. As illustrated in FIG. 6, in the first direction (X direction) perpendicular to the Z direction, the width W1c of the first top portion 26c may be equal to the width W2c of the second top portion 46c, and the width W1b of the first bottom portion 26b may be different from the width W2b of the second bottom portion 46b.

In the examples of FIG. 5A, 5B and 6, in the first direction (X direction) perpendicular to the Z direction, the smaller bottom width of one of the first spring 26 and the second spring 46 is contained within the larger bottom width of the other of the first spring 26 and the second spring 46. In contrast, as illustrated in FIG. 7, the bottom portions of the first spring 26 and the second spring 46 may be offset from each other. According to FIG. 7, the first bottom portion 26b of the first spring 26, for example, is offset from the region of the second bottom portion 46b of the second spring 46 toward +X direction side, and the second bottom portion 46b is offset from the region of the first bottom portion 26b toward -X direction side. In FIG. 7, the width of the first top portion 26c and the width of the second top portion 46c may be different from each other or may be equal to each other.

### Third Embodiment

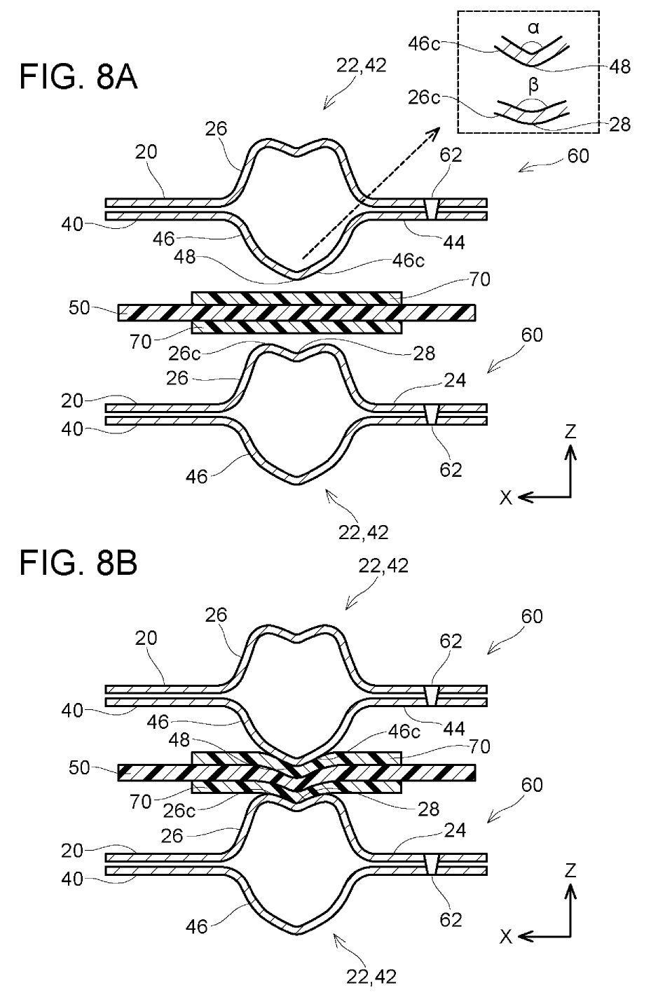

Next, the feature that the first spring 26 and the second spring 46 have asymmetric shapes with respect to the insulating member 50 is described according to a third embodiment. FIG. 8A and FIG. 8B illustrate cross sections perpendicular to the first seal line 22 and the second seal line 42 from the same viewpoint as FIG. 2A and FIG. 2B. FIG. 8A illustrates a state before the insulating member 50 is clamped by a pair of the first separator 20 and the second separator 40, and FIG. 8B illustrates a state after the insulating member 50 has been clamped by the pair of the first separator 20 and the second separator 40. FIG. 8A and FIG. 8B disclose shapes of the first spring 26 and the second spring 46 according to the third embodiment.

In the third embodiment, one of the first top portion 26c of the first spring 26 and the second top portion 46c of the second spring 46 includes a convex portion protruding toward the insulating member 50, and the other of the first top portion 26c of the first spring 26 and the second top portion 46c of the second spring 46 includes a concave portion depressed away from the insulating member 50 at a position corresponding to the convex portion. The first top portion 26c and the second top portion 46c are basically the same as those described in connection with the second embodiment. According to FIG. 8A and FIG. 8B, a convex portion 48 is formed on the second top portion 46c and a concave portion 28 is formed on the first top portion 26c. Alternatively, the convex portion 48 may be formed on the first top portion 26c and the concave portion 28 may be formed on the second top portion 46c.

When the first spring 26 and the second spring 46 press against each other to clamp the insulating member 50, as illustrated in FIG. 8B, the convex portion 48 fits into the concave portion 28 with the insulating member 50 interposed therebetween. At this time, a load applied to the concave portion 28 causes the first top portion 26c to sink in, thereby transmitting a force in the X direction as well and promoting deformation of the first spring 26 and the second spring 46. As illustrated in the enlarged diagram enclosed by the dashed frame in FIG. 8A, an internal angle α of the convex portion 48 and an internal angle β of the concave portion 28 may satisfy a relationship α < β in order to accurately fit the convex portion 48 into the concave portion 28 to enhance sealing performance. According to the third embodiment, the first spring 26 and the second spring 46 are actively deformed with the insulating member 50 interposed therebetween, by the convex portion 48 fitting into the concave portion 28. In addition, by the fitting between the convex portion 48 and the concave portion 28, the insulating member 50 is more firmly positioned between the first spring 26 and the second spring 46.

### Effects

According to the embodiments above, the first spring 26 and the second spring 46 have asymmetric shapes with respect to the insulating member 50 interposed therebetween. Thus, when they are stacked with the insulating member 50 therebetween, their deformation is promoted as compared to conventional art. Therefore, the first spring 26 and the second spring 46 can secure appropriate deformability without using conventional two-stage shape, achieving both a reduction in seal line space (i.e., a reduction in the widths of seal lines 22, 42 in the X direction according to FIG. 2A and FIG. 2B, etc.) and excellent sealing performance.

### Modification

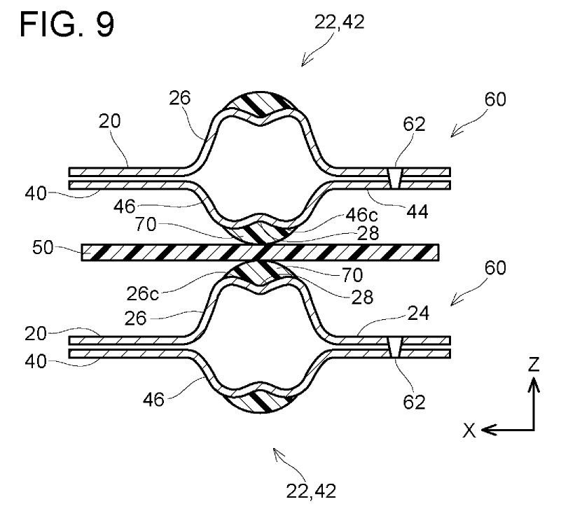

FIG. 9 illustrates a cross section perpendicular to the first seal line 22 and the second seal line 42 from the same viewpoint as FIG. 2A and FIG. 2B. FIG. 9 discloses shapes of the first spring 26 and the second spring 46 according to a modification. According to FIG. 9, the concave portion 28 is formed on each of the first top portion 26c of the first spring 26 and the second top portion 46c of the second spring 46. Then, the seal member 70 is disposed to fill each of the concave portion 28 on the first top portion 26c and the concave portion 28 on the second top portion 46c. According to this modification, when the first spring 26 and the second spring 46 press against each other to clamp the insulating member 50, each of the first top portion 26c and the second top portion 46c receives a load and becomes further depressed, promoting deformation of the first spring 26 and the second spring 46. Additionally, when the first spring 26 and the second spring 46 are deformed, the seal members 70 gather toward the centers of the concave portions 28, thereby increasing the seal line pressure applied to the insulating member 50 by the first seal line 22 and the second seal line 42.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A fuel cell comprising:
a power generation section including a membrane electrode assembly;
a frame-shaped insulating member surrounding an outer periphery of the power generation section; and
a first separator and a second separator interposing the power generation section and the insulating member therebetween in a stacking direction,
wherein the first separator comprises a first spring protruding toward the insulating member from a first facing surface of the first separator that faces the insulating member,
the second separator comprises a second spring protruding toward the insulating member from a second facing surface of the second separator that faces the insulating member, and
the first spring and the second spring have asymmetrical shapes with respect to the insulating member and interpose the insulating member therebetween.

2. The fuel cell according to claim 1, wherein the first spring comprises a first inclined surface inclined relative to the first facing surface,
the second spring comprises a second inclined surface inclined relative to the second facing surface, and
the first spring and the second spring interpose the insulating member between the first inclined surface and the second inclined surface.

3. The fuel cell according to claim 2, wherein the first inclined surface comprises a first convex portion protruding toward the insulating member and a first concave portion depressed toward the first facing surface, and
the second inclined surface comprises a second concave portion depressed toward the second facing surface at a position corresponding to a position of the first convex portion and a second convex portion protruding toward the insulating member at a position corresponding to a position of the first concave portion.

4. The fuel cell according to claim 1, wherein a width of a bottom portion of the first spring in a first direction perpendicular to the stacking direction is different from a width of a bottom portion of the second spring in the first direction.

5. The fuel cell according to claim 1, wherein a convex portion protruding toward the insulating member is formed on one of a top portion of the first spring and a top portion of the second spring, and
a concave portion depressed away from the insulating member is formed on other of the top portion of the first spring and the top portion of the second spring at a position corresponding to a position of the convex portion.
